(19) United States
(12) Patent Application Publication
(10) Pub. No.: US 2007/0182060 A1
(43) Pub. Date: Aug. 9, 2007

(54) Method for providing a thin film having a chemical composition that is spatially structured on a micrometric or nanometric scale on a substrate

(76) Inventors: Massimiliano Cavallini, Vergato (IT); Fabio Biscarini, Bolonga (IT); Daniel Ruiz Molina, Cerdanyola (ES); Jordi Gomez Segura, Cerdanyola (ES); Jaume Veciana Miro, Cerdanyola (ES)

Correspondence Address: GREER, BURNS & CRAIN, 300 S WACKER DR, 25TH FLOOR, CHICAGO, IL, 60606, US

(21) Appl. No.: 10/588,877

(22) PCT Filed: Feb. 15, 2005
(86) PCT No.: PCT/EP05/01494

§ 371 Date: Aug. 9, 2006

(30) Foreign Application Priority Data
Feb. 17, 2004 (IT) BO2004A000076

(51) Int. Cl. B27N 3/08; H05B 3/30; B32B 17/06; B32B 15/08

(52) U.S. Cl. 264/239; 428/688; 428/428; 428/626; 264/611; 264/614; 264/272.12

(57) ABSTRACT

A method for providing a thin film that is spatially structured on a submicrometric or nanometric scale, formed by a material, on a substrate, so as to obtain a product; the method comprises the steps of: dispersing the material in the substrate in order to obtain a mixture; modeling the mixture to form on a surface of the mixture protrusions and recesses; conditioning the mixture by smoothing any surface roughness thereof; by doing so, the material emerges on the surface only at the protrusions of the mixture.

### TECHNICAL FIELD

The present invention relates to a method for providing a thin film on a substrate and particularly to a method for providing a thin film having a chemical composition that is spatially structured on a micrometric or nanometric scale, constituted by patterns and/or structures having micrometric and/or nanometric dimensions.

### BACKGROUND ART

In the production for example of integrated circuits, optical devices, magnetic devices and the like, one of the best-known and Most widely used treatment methods is lithography.

One of the crucial steps in lithography entails depositing on a substrate a thin film and generating thereon a contact mask, so that during subsequent treatments the model of the mask can be transferred onto the substrate by removing the material that constitutes the substrate or by depositing another material.

A typical process of lithography in submicrometric or nanometric treatments, for providing details, consists in depositing a film on a substrate and then exposing the film with the corresponding substrate to a beam of high-energy particles, such as electrons, photons or ions, optionally through a mask that bears a chosen model.

Said beam changes the chemical structure of the exposed region of the film and leaves the unexposed region unchanged.

By immersing the substrate and the film in a developing agent, the region of film exposed to the energy beam, or alternatively the region that is not exposed, is removed, obtaining a film that reproduces the model or the corresponding negative, traced in said mask.

The print resolution that can be obtained in lithographic procedures is limited by the wavelength of the particles used to etch the film, by the properties of the film and by the developing process.

Lithographic methods based on beams of ions or electrons allow high spatial resolution (tens of nanometers), but are serial methods, i.e., the patterns are written one by one.

These techniques are limited by the scanning speed of the particle beam and accordingly are scarcely suitable for large-scale treatments and for mass production.

Parallel methods (i.e., methods that allow to write multiple patterns simultaneously) such as a photolithography are known, but they become extremely expensive when the details to be written have dimensions on the order of 100 nm, due to the costs of the materials and of the optical elements for high-energy radiation such as for example X-rays.

In order to obviate the cited drawbacks, alternative lithographic techniques have been developed which have the requirement of being parallel and at the same time allow to produce details of submicrometric and nanometric size on film in a simple way and at low cost.

An example is disclosed in patent U.S. Pat. No. 5,772,905, which proposes a lithographic method that combines conventional lithographic technologies with the less expensive method, already known with resolutions on the order of a millimeter, of pressure molding (embossing), providing moldings on nanometric or submicrometric scales (nanoembossing or nanoimprinting) of thermoplastic polymers.

This patent describes a low-cost but high-resolution lithographic approach that abandons the use of energy beams or particle beams.

Nanoembossing entails placing an appropriately shaped mold over a polymeric film placed on a rigid substrate and applying pressure, optionally accompanied by suitable heating of said substrate.

The molding generates on the film series of protrusions and recesses that correspond to the respective recesses and protrusions of said mold.

The portions of film at the recesses are then removed, obtaining on the substrate a model of film that mirrors the recesses of the mold; the polymeric film thus molded must then be developed, according to known methods, in order to obtain the intended product.

However, this method is limited by the modeling of the substrate and of the film and/or by the treatment of the silicon, which is a widely used material in these applications.

Nanoembossing, moreover, does not allow to provide directly a spatially controlled distribution of material on the substrate (otherwise known as “chemical pattern”).

The aim of the present invention is therefore to obviate the cited drawbacks by defining a method for manufacturing patterns having a different chemical nature in thin films directly on a substrate, without having to deposit or model said film but by modeling and subsequent conditioning of the substrate.

Methods for modeling by pressure molding and replication molding are widely known; in the case of pressure molding, a mold is placed in contact with a substrate and is pressed thereon so that the patterns of the mold are reproduced in negative form on the surface of the substrate, while in the replication method, a solution in which the substrate, for example a polymeric substrate, has been dissolved is deposited onto a mold, and once the evaporation of the solvent has ended the polymer solidifies and assumes the shape of the mold.

### DISCLOSURE OF THE INVENTION

The method according to the present invention proposes to provide on a substrate a chemically structured thin film by modeling, with known pressure molding or replication modeling methods, exclusively a mixture obtained by dispersing into the substrate, which is for example a polymeric substrate, the material intended to form the film; in particular, the resulting film has a chemical structure that is spatially controlled at the microscale and/or nanoscale level.

### BRIEF DESCRIPTION OF THE DRAWINGS

The technical characteristics of the invention, according to this aim, can be clearly determined from the contents of the appended claims, and its advantages will become better apparent in the following detailed description, given with reference to the accompanying drawings and photographs, which illustrate a merely exemplifying and non-limiting example of embodiment thereof, wherein:

FIGS. 1a, 1b and 1c are schematic enlarged-scale side views of a sequence of operations for modeling a mixture by pressure molding;

FIGS. 2a, 2b and 2c are schematic enlarged-scale side views of a sequence of operations for modeling the mixture by replica molding;

FIG. 3a is a schematic enlarged-scale side view of the detail B of FIG. 1c;

FIGS. 3b, 3c and 3d are schematic side views of the evolution of the mixture so as to form the spatially structured film with the method according to the present invention;

FIG. 4 is a perspective view of an image, taken with an atomic force microscope (AFM), of a replica molded mixture, obtained by using an etched digital video disc (DVD) as a mold;

FIG. 5 is a perspective view of an image, taken with an atomic force microscope (AFM), of a replica molded mixture, obtained by using a rewritable DVD as the mold;

FIG. 6 is a topographic atomic-force microscope image of a polymeric substrate with an associated film, in an intermediate stage, shown schematically in FIG. 3c, of the method according to the present invention;

FIG. 7 is a phase-contrast image of the same film as in FIG. 6;

FIG. 8 is an atomic-force microscope (AFM) topographic image of the polymeric substrate with the associated film in a stage that follows the stage shown in FIG. 6;

FIG. 9 is a magnetic-force microscope image of the polymeric substrate with the associated film in the stage of FIG. 8;

FIG. 10 illustrates a sequence of bits of a track of a DVD and a reconstruction of the topographic profile of said sequence, obtained from a track of the substrate of FIG. 8;

FIG. 11 is a view of the actual topographic profile of the substrate with the associated film, which reproduces the track of FIG. 10, obtained with the method according to the present invention;

FIG. 12 is a view of the magnetic profile that corresponds to the topographic profile of FIG. 11 and of the sequence of bits acquired from the magnetic profile as a function of the fluctuations with respect to the average value;

FIG. 13 is a view of another evolution of the film, for longer conditioning times, obtained with the method according to the present invention.

### MODES FOR CARRYING OUT THE INVENTION

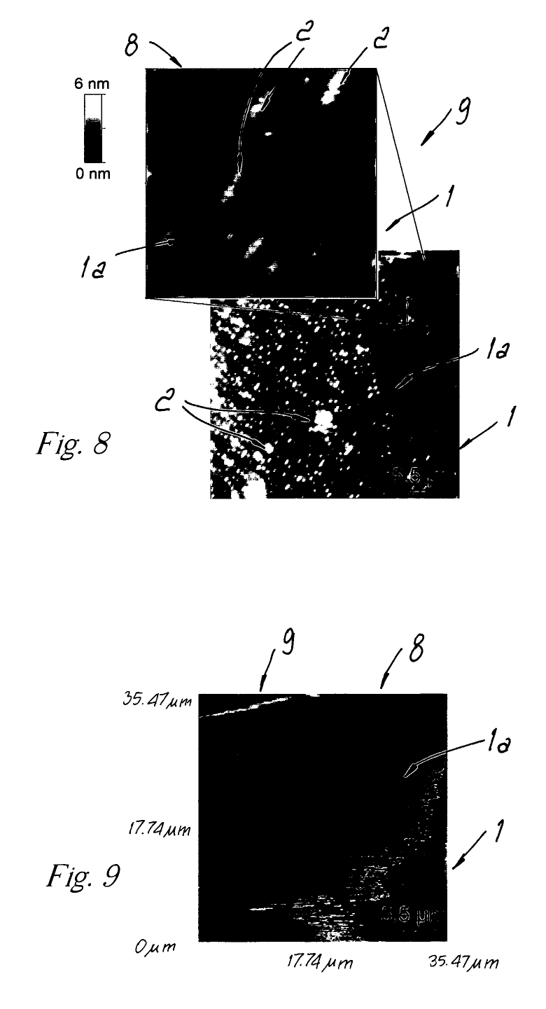

In accordance with the accompanying drawings, and with particular reference to FIG. 8, the reference numeral 1 designates the substrate and the reference numeral 1a designates a surface of said substrate; a film 2, composed of a material 3 that is originally dispersed in said substrate 1 as explained hereinafter, is formed on the surface 1a.

In the continuation of the present description, reference will be made, without thereby losing in generality, to a substrate 1 that is constituted by a polymer, particularly polycarbonate, and to a material 3 that is constituted by molecules that contain groups of 12 atoms of manganese and are known in the literature as molecular magnets (hereinafter referenced as SNM); these materials 3 are ferromagnetic at low temperatures and paramagnetic at ambient temperature. Currently, the typical paramagnetic/ferromagnetic transition temperature (known as Curie temperature) for these materials is on the order of 10 K.

These substances are taken as an example to describe the method, but said method can be applied to a wide range of materials 3 and substrates 1, including biological molecules such as for example biopolymers, proteins and the like, and copolymers; likewise, reference will be made to nanometric spatial scales, since this is the field of greatest interest in the application of the described method, which however remains valid and effective also for larger dimensions.

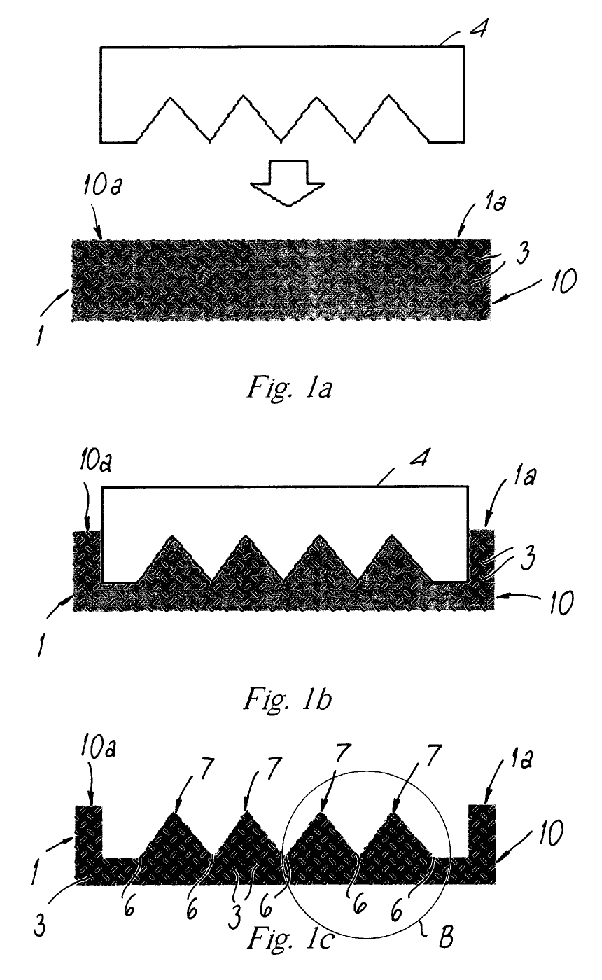

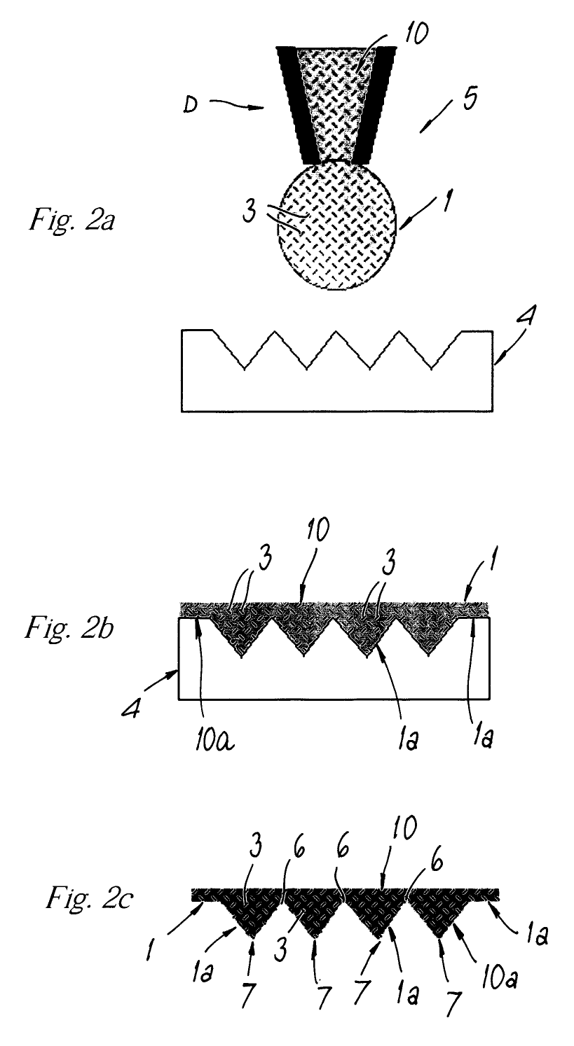

With particular reference to FIG. 1a and 2a, the method provides for a preliminary step, in which the material 3 intended to form the film 2 is dispersed uniformly in the substrate 1 in order to form a mixture 10 that accordingly comprises the substrate 1 and the material 3.

Subsequently, a surface 10a of the mixture 10, which coincides with the surface 1a of the substrate 1, is modeled, depending on the intended distribution of the film 2, on the surface la of the substrate 1, as explained hereinafter.

According to what is illustrated in FIG. 1a, 1b and 1c, the mixture 10 can be modeled by pressure with a mold 4 or, as shown in FIGS. 2a, 2b, and 2c, replica molded; in both cases, these methods are known in the modeling, for example, of polymers and therefore are described only to the extent needed for comprehension of the text, since they are applied to the mixture 10 as if it were a polymer.

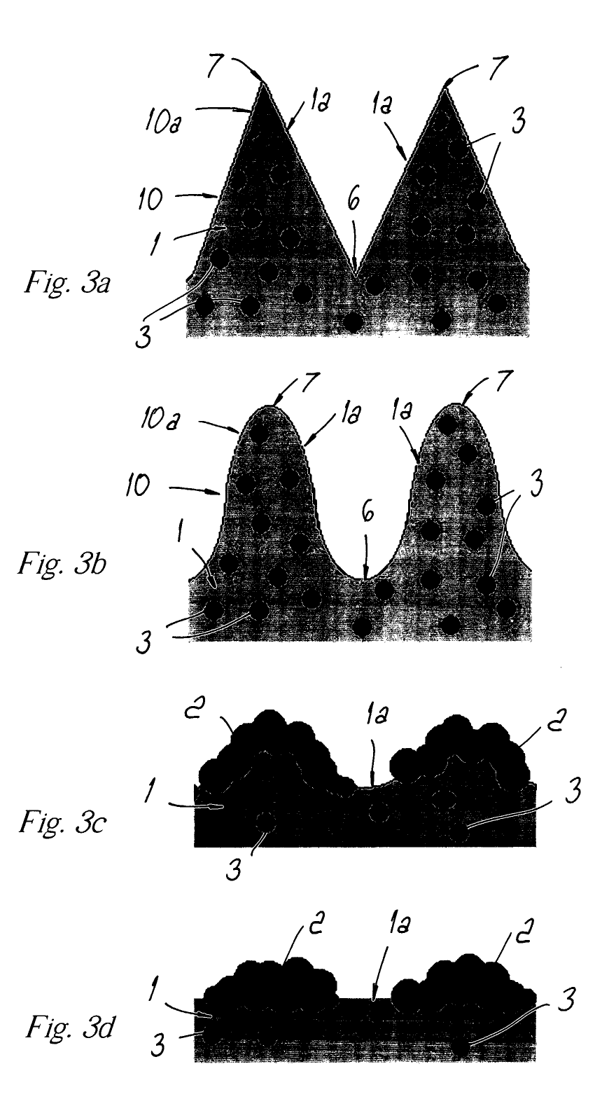

With particular reference to FIGS. 1a, 1b and 1c, in order to provide pressure molding, a nanostructured mold 4 is placed in contact with the mixture 10 and is pressed onto it in such a manner that the patterns of the mold 4, i.e., the parts in relief, are reproduced in negative form on the surface 10a of the mixture 10; this molding method can be performed after heating the mixture 10 above the characteristic glass transition temperature (Tc) of the polymer that constitutes the substrate 1, so as to make said polymer soft enough and allow to fill the recesses of the mold. FIG. 3a illustrates, in a further enlarged scale, the detail B of FIG. 1c.

With reference to FIGS. 2a, 2b and 2c, in the replica molding, a solution 5 in which the mixture 10 has been dissolved is deposited, generally in the liquid state, by means of a distribution device D on a mold 4 that is provided with a model having nanometric dimensions; according to known phenomena, the polymer solidifies and assumes the shape of the mold 4, so that the patterns of the mold 4, i.e., the the parts in relief, are reproduced in negative form on the surface 10a of the mixture 10.

Advantageously, the step for modeling the mixture 10 can occur in any way, for example also by means of a simple etching or of any method that produces on the surface 10a recesses or recessed parts 6 and protrusions or relief parts 7.

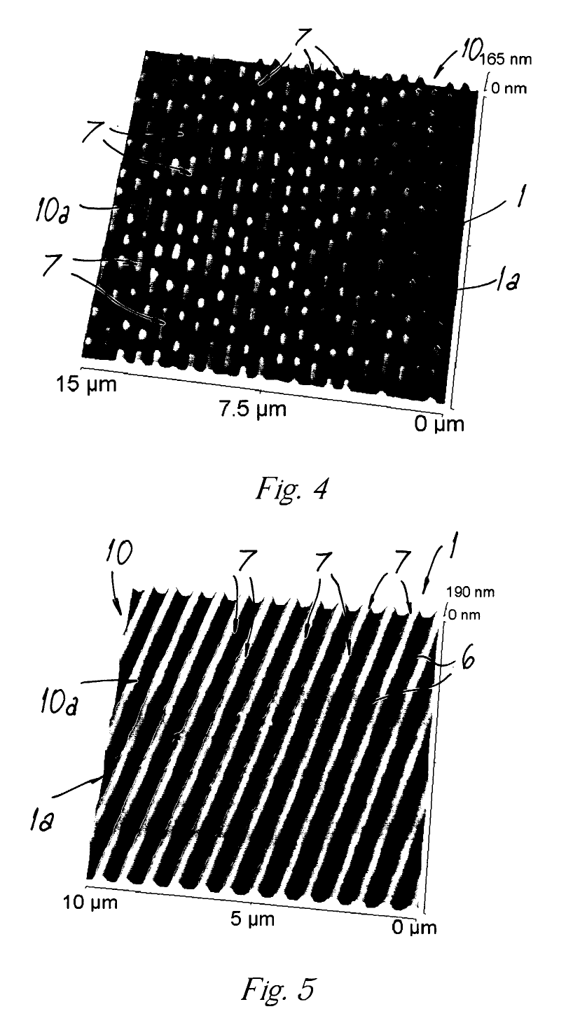

FIGS. 4 and 5 illustrate respectively an image of a replica molded mixture 10, obtained by using as a mold an etched digital video disc (DVD), and an image of a replica molded mixture 10 by using a recordable DVD as a mold.

In general, in performing the present method, the protrusions 7 on the mixture 10 correspond, as explained hereinafter, to the intended distribution of the film 2, i.e., to the intended concentration of the SMMs in the case described in the example on the surface 1a of the substrate 1.

In particular, therefore, if one wishes to provide on the surface 1a of the substrate 1 a precise distribution of the dispersed material 3, it is necessary to provide the mold 4 so that it produces on the mixture 10 the protrusions 7 that have shapes and dimensions that correspond to the intended distribution of material 3; in order to model the mixture 10 and form the film 2, as shown for example in FIG. 8, an etched DVD, as in FIG. 4, has been used as a mold.

At the end of the modeling process, the mixture 10 is exposed to a solvent or to solvent vapors, for example, without losing in generality, in the case of polycarbonate and SMM, to dichloromethane; in the case of exposure to the solvent, the substrate 1 preferably is at least partially soluble in a solvent.

According to known phenomena, this exposure induces substantially two effects: the smoothing of the surface 10a of the mixture 10, or the reduction of the roughness of the surface 1a of the substrate 1, and the surfacing of the SMM molecules, i.e., of the dispersed material 3, on said surface 1a, at first in isolation and then, by extending the exposure time, in groups which first form a thin film of SMMs and then form aggregates that are shaped like a closed ring, particularly due to the dewetting of the thin film 2 of material 3 that has emerged from said substrate 1.

With particular reference to FIGS. 3b, 3c and 3d, it is noted that at the relief parts 7, simultaneously with a rounding thereof, more molecules 3 emerge with respect to the recessed parts 6, and by continuing the exposure to the solvent the aggregation and subsequent evolution of the film 2 on the surface 1a of the substrate 1 is anticipated at the regions 7 that were previously in relief as the surface 10a of the mixture 10 has been molded beforehand.

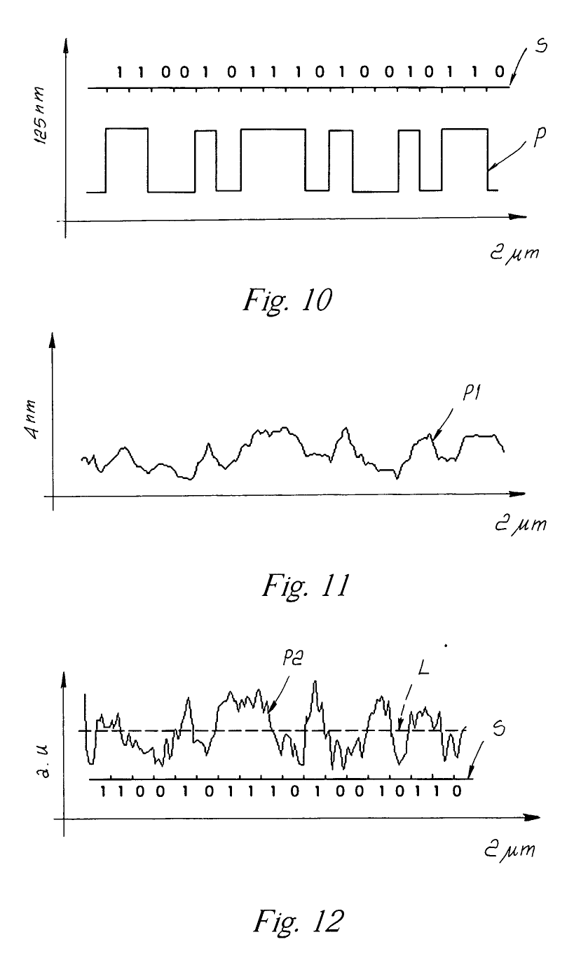

This localized emergence forms, in the case of polycarbonate and molecular magnets of the example, permanent magnetic memory elements 8, shown in FIGS. 8, 9 and 12.

These elements 8 are therefore constituted by a polymeric substrate 1 (in which, however, some isolated molecules of material 3 remain dispersed, their presence being negligible and allowing to refer, in this step, simply to the substrate 1 and not to a mixture 10) and by a film 2 constituted by SMMs; in the elements 8, the material 3 having magnetic properties is more concentrated in the regions of the mixture 10 that were previously in relief; the material 3 that is initially dispersed within the polymer 1 emerges on the surface 1a thereof following exposure to the solvent and aggregates in the film 2.

The molecules emerge on the entire surface 1a of the polymer but with a different concentration, i.e., a higher concentration where the relief parts 7 were located; moreover, not all the material 3 concentrates on the surface 1a, but a part remains embedded and dispersed within the polymer, as shown schematically by way of example in FIG. 3d.

Consequently, molecule aggregates form in certain regions and evolve, forming continuous films 2, and in the regions that were originally recessed the emerged molecules remain isolated because not enough material 3 emerges to form the films 2 or large aggregates (except for very long exposures to the solvent).

This surface aggregation, obtained in the case shown in example by exposing the mixture 10 to solvent vapors, can also occur by means of a suitable thermal treatment of said mixture 10.

It should be noted that in the case of emergence obtained by exposure to a solvent, the substrate 1 must have suitable surface dissolution characteristics, according to known phenomena.

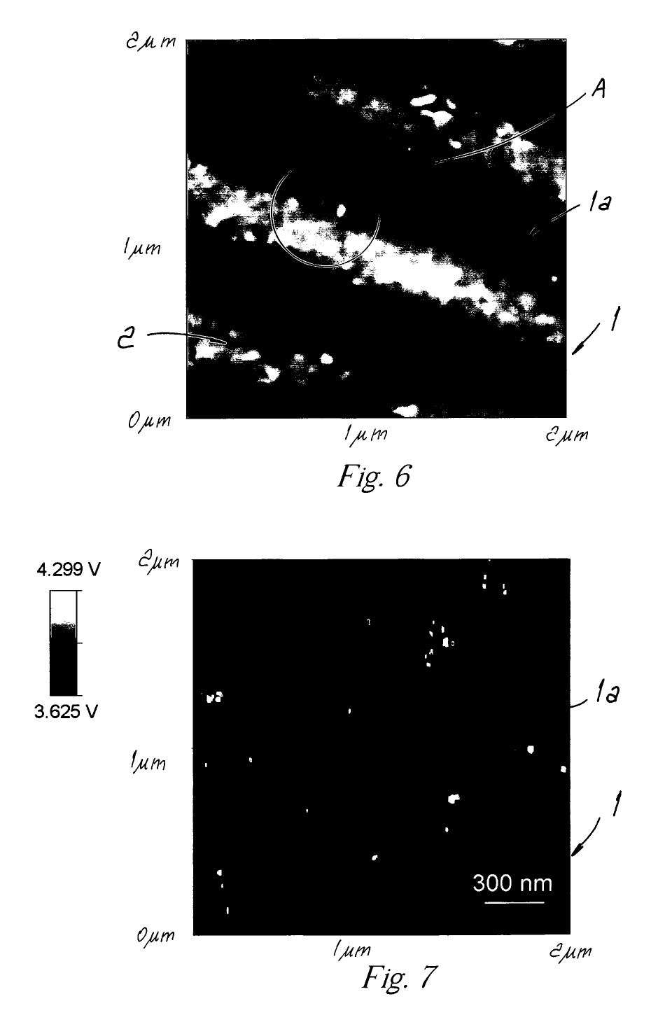

Images of the various steps of aggregation in a modeled specimen are visible in FIGS. 6, 7, 8, 9 and 13, which refer to a polycarbonate substrate 1 that contains 3% SMMs by weight with respect to the weight of the polymer.

It should be noted that by varying the amount of material 3 dispersed within the substrate 1, the aggregation times of the material 3 on the surface la change; these times depend on the nature of the materials used, on the nature of the substrate 1, on the value of the roughness of the modeled substrate 1, and on environmental conditions such as temperature and relative humidity.

Advantageously, these aggregation times might be adjusted by varying the environmental conditions in which the method according to the invention is developed.

In particular, for an equal conditioning time and if the temperature is set, the film 2 might be provided by acting on the ambient humidity, and likewise, if the humidity is fixed, the film 2 might be provided by acting on the ambient temperature.

FIG. 6 in particular illustrates a substrate 1 in which the material 3 is dispersed after exposure to the solvent (in the particular case, dichloromethane) for 200 seconds with an ambient temperature of 23° C. and an ambient relative humidity of 51%.

Considering the feature A of said image, it can be seen that an aggregation as shown schematically in FIG. 3c has occurred.

FIG. 7 is an image produced by phase contrast, a method that is known for highlighting the different chemical or physical nature of materials present on a surface of the substrate 1 in the same conditions of FIG. 6.

By extending the exposure to the solvent of the substrate 1 and of the material 3 of FIG. 6, in particular by exposing it to the solvent for 300 seconds with the same temperature and humidity conditions described earlier, the aggregation state, shown in FIG. 8 and also shown schematically in FIG. 3d, is reached.

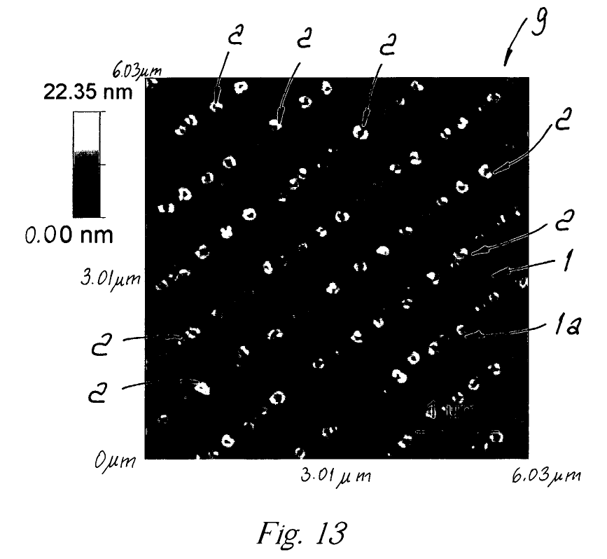

Moreover, it can be noted that by extending the exposure to the solvent up to 400 seconds, the dispersed material 3 aggregates as shown in FIG. 13.

With particular reference to FIG. 10, a sequence S of bits of a track of the DVD used to model the mixture 10 as shown in FIG. 4 is observed, and so is the reconstruction of the original topographic profile P (i.e., before conditioning) of said track on the mixture 10.

FIG. 11 is a view of the actual topographic profile P1 of the substrate 1 and of the corresponding film 2 after exposure to the solvent of the mixture 10 of FIG. 4.

Said topographic profile P1 relates to the actual image of FIG. 8, i.e., after 300 seconds of exposure, and FIG. 12 illustrates its magnetic profile P2, measured with the magnetic-force microscope.

It is noted that if one considers an average line L of the signal, the fluctuations reproduce exactly the same original bit sequence S.

In this way, a film 2 that has the characteristics of the material 3 dispersed in the polymer and is provided with a spacing that corresponds to the protrusions previously provided on the surface 10a of the mixture 10 is substantially formed on the surface 1a of the substrate 1.

By applying the method with different substrates 1 and materials 3, a method for manufacturing numerous products 9 is defined.

In particular, if the material 3 is a conducting material, for example metal, a method is provided for manufacturing conducting wires and electrodes composed of a substrate 1 on which the conducting material 3 is conveniently arranged; if the material 3 has magnetic properties (i.e., is paramagnetic or ferromagnetic), a method is provided for manufacturing magnetically readable memory elements as in the previously described example, said elements being optionally rewritable for particular dispersed materials 3, for example ferromagnetic materials; if the material 3 has optical properties (for example has photoluminescence and/or electroluminescence properties), a method is defined for manufacturing optically readable memory elements which can be rewritable for particular materials 3, such as for example optical switches.

In general, a method is therefore provided for organizing in a spatially controlled manner, on a submicrometric and/or nanometric scale, a material 3 on a substrate 1 so that the properties of the material 3 dispersed originally in the substrate 1 define the characteristics of the product 9 obtained with said method, as a function of the distribution of the film 2 obtained on the surface 1 a of said substrate 1.

The spatially controlled distribution of the material 3 on the substrate 1, also termed “chemical pattern”, is itself a useful product in various production processes, such as for example a substrate for the differentiated growth of thin films or a step of a manufacturing process; advantageously, said method can also be used with substrates 1 that are organic, inorganic or biological in nature.

This method can also be used with any type of material 3 and substrate 1 in order to obtain, without losing in generality, light emitting diodes, field- effect transistors, diodes and other devices.

In particular, the substrate 1 can be an organic, inorganic or biological substrate and likewise the dispersed material 3 can be an organic or inorganic material; according to further embodiments, the method according to the invention can be used with substrates 1 based on gels or substrates that comprise polymeric mixtures.

If the dispersed material 3 is a semiconductor, it is possible to obtain an electrode or even a film 2 in which the semiconductor is the active element.

The present invention also relates to an electrode, an optically readable and rewritable or non-rewritable memory element, a magnetically readable and rewritable or non-rewritable memory element obtained with the method described above, and to a spatially structured chemical pattern.

Advantageously, once the material 3 has emerged on the surface 1a of the substrate 1, forming the film 2, it can be treated chemically or by physical processes (for example thermal treatments or exposure to ions, photons or others) in order to change its intrinsic properties; moreover, a chemical treatment can also be used to cover said film 2 with a protective layer.

The invention achieves the proposed aim and objects, and in particular the method allows to manufacture directly thin-film patterns on a corresponding substrate without having to resort to lithographic processes.

This method uses in a novel way the emergence of a material dispersed in a substrate, following exposure to a solvent, by making the material concentrate in certain regions following a conditioning of the mixture with said material dispersed therein, before exposing it to said solvent.

Substantially, this method allows to distribute in a controlled manner, with the chosen spatial arrangement, a material that is initially dispersed in a polymer on the surface of said polymer.

The method as described operates on a micrometric and nanometric scale and is fully within the field of nanotechnologies.

It should be noted that a product 9 thus obtained is the result of a kinetic process, not of a thermodynamic process, and has substantially no topography but a precise state of aggregation of the material 3 on the surface 1a of the substrate 1.

The invention thus conceived is susceptible of various industrial applications; it can also be the subject of many modifications and variations, all of which are within the scope of the appended claims; all the details may further be replaced with technically equivalent elements.

The disclosures in Italian Patent Application No. BO2004A000076 from which this application claims priority are incorporated herein by reference.

Where technical features mentioned in any claim are followed by reference signs, those reference signs have been included for the sole purpose of increasing the intelligibility of the claims and accordingly such reference signs do not have any limiting effect on the interpretation of each element identified by way of example by such reference signs.

1-45. (canceled)

46. A method for providing a thin film on a substrate in order to obtain a product, said film being formed by a material, comprising the steps of:
dispersing said material in said substrate in order to obtain a mixture;
modeling said mixture;
conditioning said mixture.

47. The method according to claim 46, wherein said modeling step comprises a step for forming, on a first surface of said mixture, protrusions and recesses.

48. The method according to claim 47, wherein said conditioning step comprises a step of causing said material to emerge on a second surface, said step of causing said material to emerge comprising the step of smoothing said mixture in order to smooth any surface roughness, said surface roughness further comprising said protrusions.

49. The method according to claim 48, wherein said smoothing step comprises a step of exposing said mixture to a solvent.

50. The method according to claim 48, wherein said smoothing step comprises a step of heating said mixture.

51. The method according to claim 48, comprising a step of treating, chemically and/or by means of any physical treatment, said emerged material in order to modify its intrinsic properties.

52. The method according to claim 51, wherein said chemical treatment step comprises a step for coating said emerged material with a protective layer.

53. The method according to claim 46, wherein said modeling step comprises a step of etching said mixture.

54. The method according to 46, wherein said modeling step comprises a step of pressure molding said mixture.

55. The method according to claim 53, wherein said modeling step comprises a step of heating said mixture in order to soften said substrate.

56. The method according to claim 46, wherein said modeling step comprises a step of replica molding said mixture.

57. The method according to claim 46, wherein said substrate comprises a polymeric mixture.

58. The method according to claim 46, wherein said substrate comprises a polymer.

59. The method according to claim 58, wherein said polymer comprises polycarbonate.

60. The method according to claim 46, wherein said substrate comprises a copolymer.

61. The method according to claim 46, wherein said substrate comprises a molecular material.

62. The method according to claim 46, wherein said substrate comprises biological molecules.

63. The method according to claim 46, wherein said substrate comprises a gel.

64. The method according to claim 46, wherein said substrate is an organic material.

65. The method according to claim 46, wherein said material is an inorganic material.

66. The method according to claim 46, wherein said material is a biological material.

67. The method according to claim 46, wherein said substrate is an organic material.

68. The method according to claim 46, wherein said material is an inorganic material.

69. The method according to claim 46, wherein said material is a biological material.

70. The method according to claim 46, wherein said substrate is soluble in a solvent.

71. The method according to claim 46, wherein said material is a conducting material and the resulting product is an electrode, said film being a conducting film.

72. The method according to claim 71, wherein said conducting material comprises a metal or metallic particles.

73. The method according to claim 46, wherein said material is a semiconducting material and the resulting product is an electrode.

74. The method according to claim 46, wherein said material is a semiconducting material and the resulting product is an electronic device or photovoltaic cell or light-emitting diode, said film being a semiconducting film.

75. The method according to claim 46, wherein said material is a magnetic material and the resulting product is a magnetically readable memory element.

76. The method according to claim 71, wherein said magnetically readable memory element is rewritable, said magnetic material being ferromagnetic.

77. The method according to claim 46, wherein said material has optical properties and the resulting product is an optically readable memory element.

78. The method according to claim 77, wherein said optically readable memory element is rewritable.

79. The method according to claim 46, wherein the parameters of temperature and humidity are fixed, wherein said production of the film is regulated by acting on the duration of said conditioning step.

80. The method according to claim 46, wherein the parameters of temperature and time are fixed, and wherein said production of the film is regulated by acting on the humidity parameter in said conditioning step.

81. The method according to claim 46, wherein the parameters of humidity and time are fixed, and wherein said production of the film is regulated by acting on the temperature parameter in said conditioning step.

82. A spatially structured chemical pattern, wherein it is obtained according to the method described in claim 46, said pattern being constituted by said material.

83. An electrode, wherein it is obtained: according to the method described in claim 46, said material being a conducting material.

84. An electrode, wherein it is obtained according to the method described in claim 46, said material being a semiconducting material.

85. The electrode according to claim 83, wherein said conducting material is metallic.

86. A magnetically readable memory element, wherein it is obtained according to the method described in claim 46, said material being a magnetic material.

87. A magnetically readable memory element according to claim 86, wherein it is rewritable, said magnetic material being ferromagnetic.

88. An optically readable memory element, wherein it is obtained according to the method described in claim 46, said material having optical properties.

89. An optically readable memory element according to claim 88, wherein it is rewritable.

90. The method according to claim 54, wherein said modeling step comprises a step of heating said mixture in order to soften said substrate.
